(19) United States
(12) Patent Application Publication
(10) Pub. No.: US 2004/0098892 A1
(43) Pub. Date: May 27, 2004

(54) Visual display apparatus

(76) Inventor: John Michael Brennan, Kedron (AU)

Correspondence Address: Laura G Barrow, Hahn Loeser + Parks, PO Box 215, Estero, FL, 33928-0215, US

(21) Appl. No.: 10/333,863

(22) PCT Filed: Jul. 24, 2001
(86) PCT No.: PCT/AU01/00902

(30) Foreign Application Priority Data
Jul. 25, 2000 (AU) PQ8987

(51) Int. Cl. G09F 7/14; G09F 1/00; G09F 9/00

(52) U.S. Cl. 40/449; 40/446

(57) ABSTRACT

A visual display apparatus (1) is disclosed which finds particular use as a sign in retail advertising or as a toy whereby a child can arrange display elements (5) in an appealing pattern. The sign (1) includes a ferromagnetic support (2) upon which magnetic display elements (5) can be positioned. Each element (5) comprises a magnetic base (10), an axle (11) projecting up from the magnetic base (10) through the bore (30) of a peripherally-toothed disc-like gear (13) and through the bore (31) of a spacer (19), the spacer (19) being affixed to the toothed gear (13), and a disc-shaped display sheet (15) mounted on the spacer (19) and fast therewith. The toothed gears (13) of adjacent elements (5) engage so that rotational movement of one element (5) causes movement of the adjacent element (5). Adjacent elements (5) are placed on the support surface to spell out a word or other required advertising. An electric motor is the preferred power source to rotate the display element (5) although manual operation is possible.

This invention relates to a visual display apparatus.

This invention relates particularly, but not exclusively, to a visual display apparatus which is a sign displaying visual information in a way designed to attract a person's attention. It will therefore be convenient hereinafter to describe this invention with reference to this example application. However, it is to be clearly understood that the invention is capable of broader application. A particularly envisaged application of the invention is as a sign in retail advertising.

Signage is used frequently in retail advertising, particularly to advertise specials, prices of goods, etcetera. It is always advantageous to present this information in a visually striking manner which will be likely to attract attention. It would be advantageous if a sign could be devised that was capable of easily having the information displayed thereon moved around and varied so as to display new and different information.

According to the present invention, there is provided a visual display apparatus, said apparatus including:

a support having at least one support surface;

a plurality of display elements, each of said display elements being:

(i) releasably attachable to said support surface;

(ii) capable of being positioned on said support surface in a position chosen by a user of said apparatus; and

(iii) adapted for rotational motion while mounted on said support surface; and

driving means to impart rotation to at least one of said display elements;

wherein at least some of said display elements are coupled to each other such that rotation of one of said display elements causes rotation of at least one adjacent of said display elements.

Preferably, the display element is releasably attached to the support means by attachment means selected from one or more of the group consisting of magnetic attachment means, fabric attachment means and adhesive- or putty-like attachment means.

When the attachment means is the magnetic attachment means, a magnet is either associated with the support surface or is incorporated into the display element.

When the attachment means is a fabric attachment means, a suitable fabric attachment means is the material sold under the trade mark “velcro”.

Preferably, the display element incorporates the magnet for releasably attaching the display element to the support surface.

Preferably, a toothed gear is rotatably mounted on the magnet and adapted for rotatably coupling to the toothed gear of an adjacent display element.

Preferably, the toothed gear is manufactured from any suitable material which will reduce the loss of energy in transmitting drive from the driving means between adjacent display elements.

Preferably, the magnet includes an axle extending away from the support surface and passing through a bore in the toothed gear.

Preferably, the axle includes an enlarged end for retaining the toothed gear thereon.

Preferably, the magnet is adapted such that toothed gears of adjacent display elements engage at a desired pitch.

Preferably, the magnet has a surface area similar to the toothed gear.

Preferably, a display sheet is mounted on, and affixed to, the toothed gear.

Preferably, the display sheet has a reflective upper surface.

The reflective upper surface may be a mono- or multi-coloured surface.

When the reflective surface is mono-coloured, said reflective surface is a silver reflective material.

Preferably, the silver reflective material is a holographic foil.

When the reflective surface is multi-coloured, the reflective surface can incorporate any desired pattern.

Preferably, the display sheet is sized to at least cover the toothed gear.

Where the display sheet is of a size substantially larger than the toothed gear, the apparatus further includes a spacer positioned on the axle and between the toothed gear and the display sheet to allow a staggered overlap or overlay of adjacent display sheets, thus preventing interference of adjacent display sheets.

The support surface may be manufactured from, or associated with, a ferromagnetic material.

Where the support surface is associated with a ferromagnetic material, the support surface can include a first layer having an upper surface upon which is placed the display element(s) adapted to be visually attractive and a second layer of ferromagnetic material positioned on or near the under surface of the first layer and sufficiently proximate to maintain attachment of the display element(s) on the first layer.

The support surface may be adapted to enable display elements to be positioned on two sides thereof.

Preferably, the means for rotating the display element is a direct current electric motor.

The electric motor may be powered by any suitable means, including battery, solar or mains power.

The electric motor may be positioned on the same side of the support surface as the display elements and be driveably coupled to a drive gear which, in turn, is driveably coupled to the toothed gear of an adjacent display element; or it may be positioned on the side of the support surface opposite to that upon which the display elements are attached and have a shaft passing through the support surface which is driveably coupled to a drive gear which, once again in turn, is driveably coupled to the toothed gear of an adjacent display element; or it may be positioned on one side of the support surface as convenient and have a shaft passing through the support surface driveably coupled to a drive gear which can be driveably coupled to the toothed gear of an adjacent display element, but is further adapted to be movable substantially orthogonal to the plane of the support surface so that the drive gear on the shaft can engage the toothed gear of a display element on either side of the support surface as may be required—particularly useful where the support surface is adapted to accept display elements on two opposing sides of the support surface; or it may be positioned on one side of the support surface but having a shaft passing through the support surface, the shaft having two drive gears, the first gear driveably coupled to a toothed gear of an adjacent display element on one side of the support surface and the second gear being driveably coupled to a toothed gear of an adjacent display element on the other side of the support surface.

A display apparatus in accordance with this invention may manifest itself in a variety of forms. It will be convenient to hereinafter describe, in detail, a number of preferred embodiments of the invention with reference to the accompanying drawings. The purpose of providing this detailed description is to instruct persons having an interest in the subject matter of the invention how to carry the invention into practical effect. It is to be clearly understood, however, that the scope or ambit of the invention is to be determined by reference to the preceding broad description and not the following specific description. In the drawings:

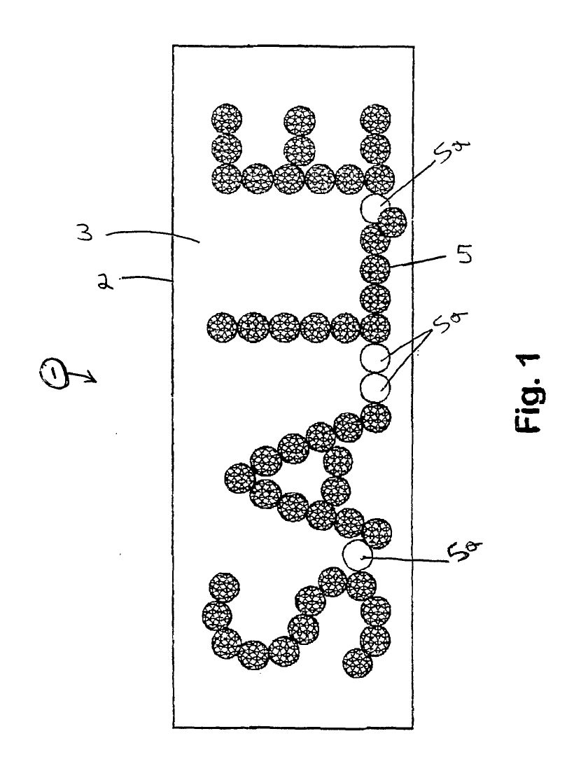

FIG. 1 is a front view of a visual display apparatus in accordance with the present invention;

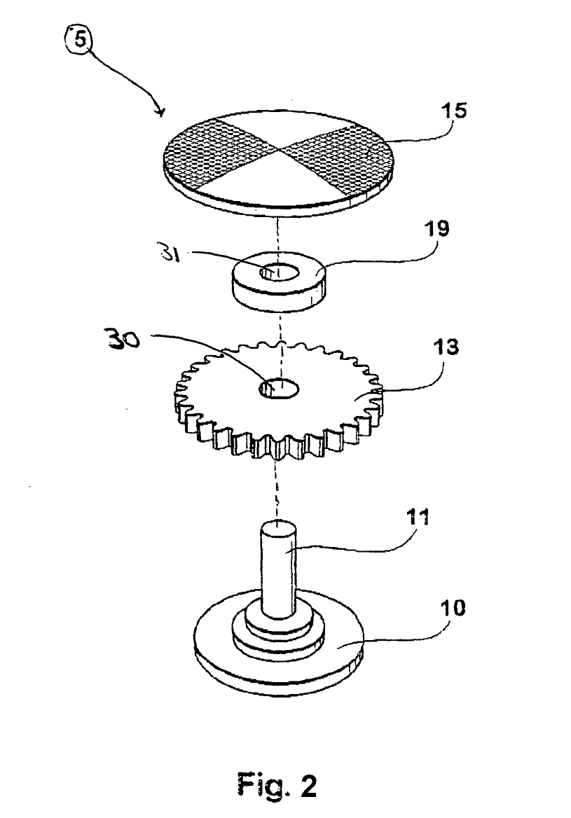

FIG. 2 is an exploded view of a display element of the apparatus of FIG. 1;

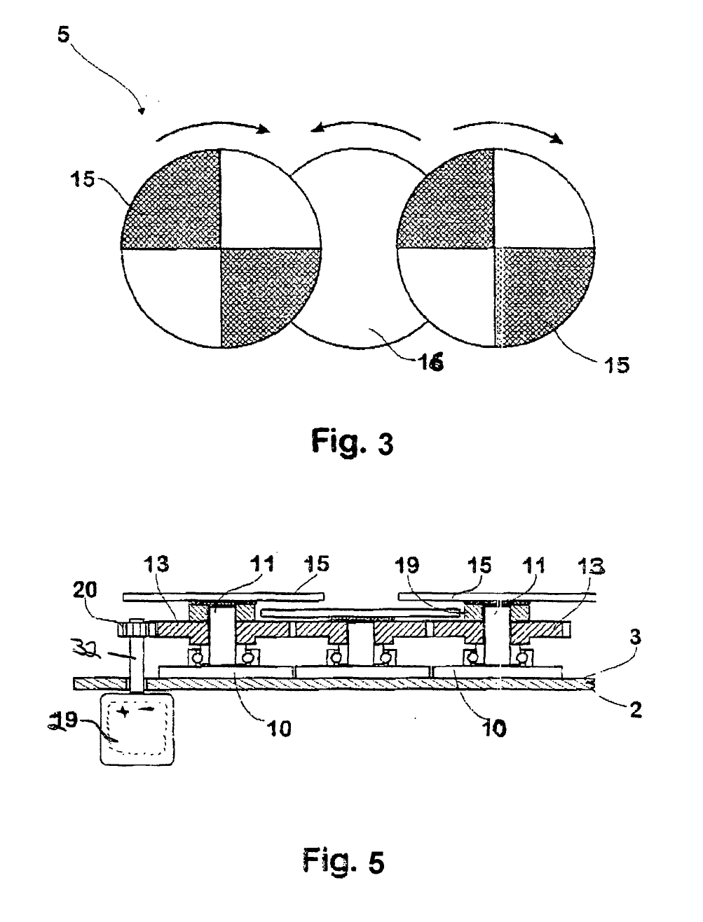

FIG. 3 is a plan view of a first section of the apparatus of FIG. 1;

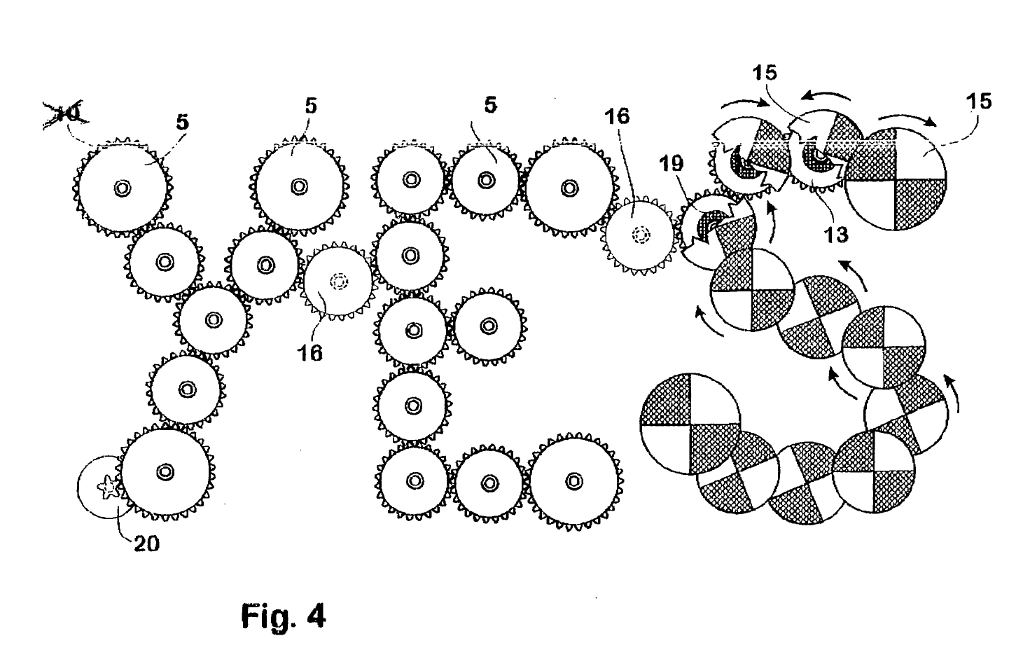

FIG. 4 is a plan view of a second section of the apparatus of FIG. 1;

FIG. 5 is a sectional view of a first drive arrangement of the present invention;

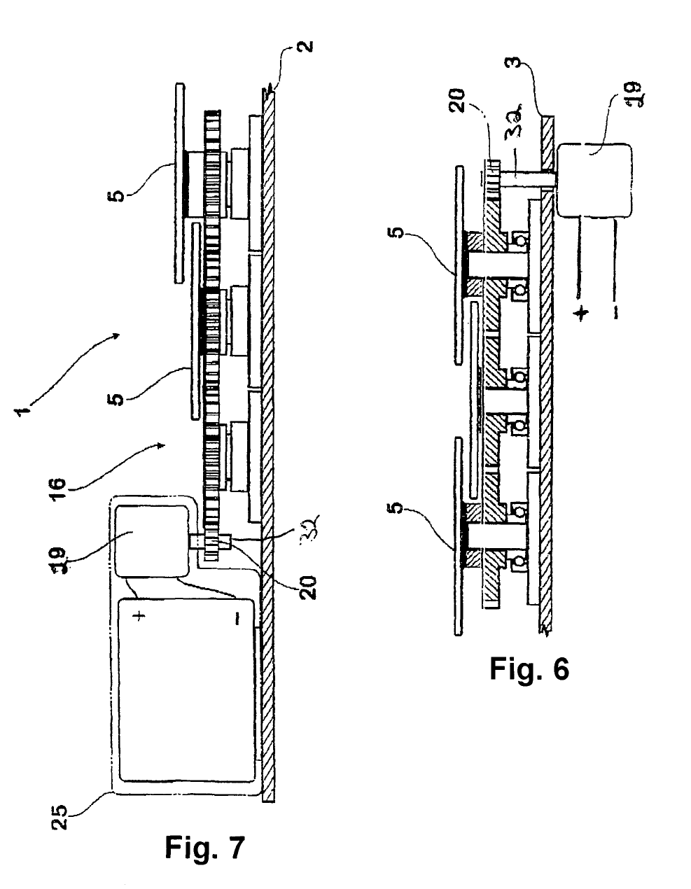

FIG. 6 is a sectional view of a second drive arrangement of the present invention;

FIG. 7 is a sectional view of a third drive arrangement of the present invention;

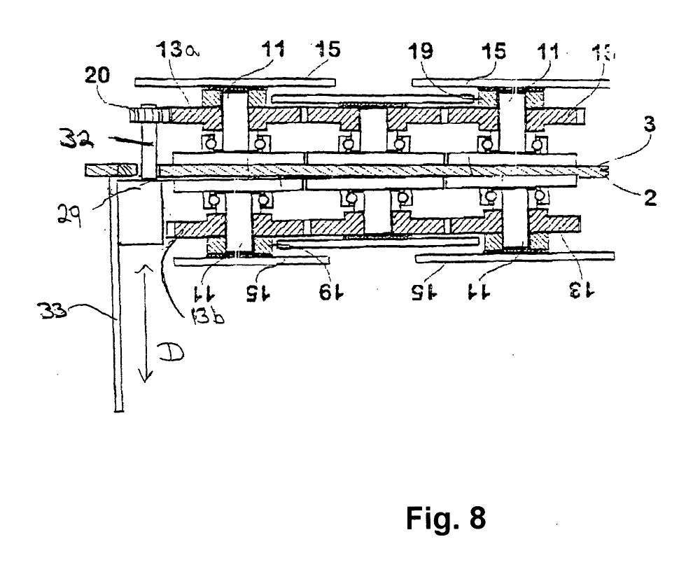

FIG. 8 is a sectional view of a fourth drive arrangement of the present invention; and

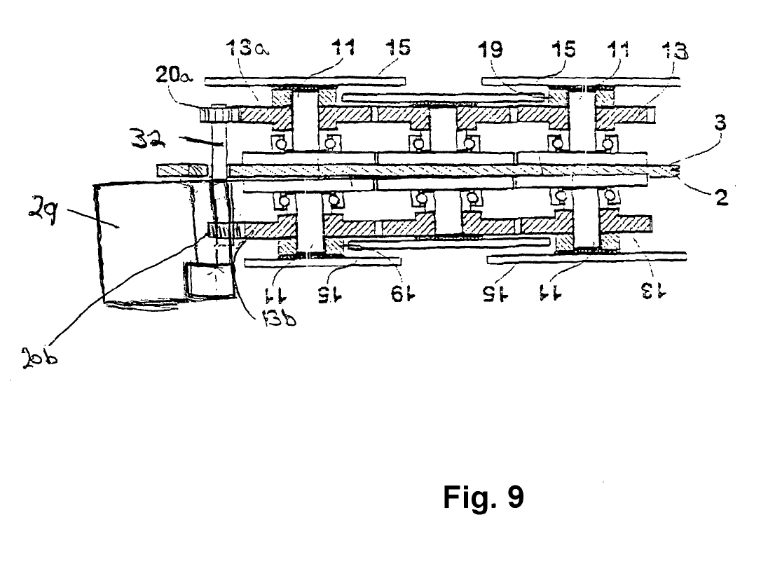

FIG. 9 is a sectional view of a fifth drive arrangement of the present invention.

In FIG. 1, reference numeral (1) refers generally to a visual display apparatus in accordance with the invention which is a display sign. The display sign (1) includes a support in the form of a rectangular ferrous steel sheet (2) having a planar support surface (3) on which a plurality of display elements (5) are positioned.

As illustrated in FIG. 2, each element (5) comprises a magnetic base (10), an axle (11) projecting up from the magnetic base (10) through the bore (30) of a peripherally-toothed disc-like gear (13) and through the bore (31) of a spacer (19), the spacer (19) being affixed to the toothed gear (13), and a disc-shaped display sheet (15) mounted on the spacer (19) and fast therewith. With the exception of elements (5a) (FIG. 1), the display sheet (15) is made of a reflective holographic material. The display sheets (15) of the display elements (5a) are of the same colour as the support surface (3) so as to not be obviously visible to a person reading the sign (1) and thus creating the illusion of a spacing between the letters of the word SALE (FIGS. 1 & 3).

The magnetic bases (10) are substantially circular and are sized to be slightly smaller than the gears (13). When the magnetic bases (10) of adjacent elements (5) are in abutting contact with each other, the relative positioning of the gears (13) is such as to fully mesh and engage with each other (FIG. 4). The spacers (19) are also of varying thickness so that display sheets (15) which overlap do not interfere with each other (FIG. 5).

As depicted In FIGS. 5 & 6, a drive motor (29) is affixed to the under surface of the sheet (2). A drive shaft (32) extends through a bore in the sheet (2) and terminates in a drive gear (20) which engages an adjacent gear (13) of a display element (5). The motor (29) is a DC electric motor of a type well known in the art and can be energized by a battery (eg a 1.2 V battery) (FIG. 5) or can be mains supplied (FIG. 6).

In an alternative embodiment (FIG. 7), the motor (29) and its associated battery are contained within a magnetic housing (25) which is held to the same side of the sheet (2) as the display elements (5).

In yet another alternative embodiment (FIG. 8), the motor (29) and its associated battery within the magnetic housing (25) can slide on a facing (33) which depends from the sheet (2), there being a bore in the sheet (2) sufficient to allow the drive gear (20) to pass through in the bi-direction “D”. In one position (as illustrated), the drive gear (20) engages the toothed gear (13a) of a display element (5) on one side of the sheet (2). In a second position, the motor (29) is repositioned along the facing (33) such that the drive gear (20) engages the toothed gear (13b) of a display element (5) on the other side of the sheet (2).

FIG. 9 depicts an alternative drive for those embodiments of the present invention wherein a display element(s) is on both sides of the sheet (2) as illustrated in FIG. 8. In this alternative, the motor (29) has a drive shaft (32) that extends through a bore in the sheet (2). At the free end of the shaft (32) a first drive gear (20a) engages an adjacent toothed gear (13a) on one side of the sheet (2). At the other end of the shaft (32) there is a second drive gear (20b) which engages the toothed gear (13b) of a display element (5) on the other side of the sheet (2).

In use, 51 display elements (5) are used to spell out the word SALE (FIG. 1). Display elements (5) with their reflective display sheets (15) are used to spell the letters S, A, L and E. The display sheets (15) of the display elements (5a) that are of the same colour as the support surface (3) are used to link the adjacent letters. Upon energizing the motor (29), all display elements (5) are caused to rotate.

To change the content of the display sign (1) when it is desired to do so, the elements (5) are merely picked up and/or slid around the support surface (3) to form a new signage. It will be appreciated, however, that adjacent elements (5) must engage with each other so as to transmit drive from one to the other to cause rotation thereof.

The display sign (1) can be further enhanced by additional wording or graphics applied to a sheet(s) of paper or other material which may be placed on the support surface (3), under the display elements (5), and held in place on the support surface (3) by the magnetic bases (10) of the display elements (5).

The present invention thus provides a sign that offers a number of advantages which include:

it is visually eye catching and striking;

the arrangement of the elements on the surface of the sign can be easily changed manually by a user;

in motorized form, only low energy consumption is required and is therefore suited to be driven by a low voltage battery;

it is not necessary to drill holes in the support surface to anchor or mount the display elements;

in motorized form, there is no complex attachment of the housing which houses the electric motor to the sign; and

by appropriate sizing of the magnetic base of the display element, a full and effective engagement of adjacent gears is possible.

The display apparatus of the present invention is thus expected to find use at least as (1) signage, e.g. commercial signage, including retail advertising; and (2) as a toy, e.g. with a child arranging the display elements in a pattern on the support surface and then causing them to rotate.

It will of course be realized that the above has been given only by way of illustrative example of the invention and that all such modifications and variations thereto as would be apparent to persons skilled in the art are deemed to fall within the broad scope and ambit of the invention as defined in the following claims.

1. A visual display apparatus, said apparatus including:
a support having at least one support surface;
a plurality of display elements, each of said display elements being:
(i) releasably attachable to said support surface;
(ii) capable of being positioned on said support surface in a position chosen by a user of said apparatus; and
(iii) adapted for rotational motion while mounted on said support surface; and
driving means to impart rotation to at least one of said display elements;
wherein at least some of said display elements are coupled to each other such that rotation of one of said display elements causes rotation of at least one adjacent of said display elements.

2. An apparatus as defined in claim 1, wherein each of said display elements is releasably attached to said support means by attachment means selected from one or more of the group consisting of magnetic attachment means, fabric attachment means and adhesive- or putty-like attachment means.

3. An apparatus as defined in claim 2, wherein said attachment means is said magnetic attachment means.

4. An apparatus as defined in claim 3, wherein a magnet of said attachment means is either associated with said support surface or is incorporated into each of said display elements.

5. An apparatus as defined in claim 2, wherein said attachment means is a fabric attachment means.

6. An apparatus as defined in claim 5, wherein said fabric attachment means is the material sold under the trade mark “velcro”.

7. An apparatus as defined in claim 4, wherein each said display element incorporates said magnet.

8. An apparatus as defined in claim 7, wherein a toothed gear is rotatably mounted on said magnet and adapted for rotatably coupling to a said toothed gear of an adjacent said display element.

9. An apparatus as defined in claim 8, wherein said magnet includes an axle extending away from said support surface and passing through a bore in said toothed gear.

10. An apparatus as defined in claim 9, wherein said axle includes an enlarged end for retaining said toothed gear thereon.

11. An apparatus as defined in any one of claims 8 to 10, wherein said magnet is adapted such that said toothed gears of adjacent said display elements engage at a desired pitch.

12. An apparatus as defined in any one of claims 8 to 11, wherein said magnet has a surface area similar to said toothed gear.

13. An apparatus as defined in any one of claims 8 to 12, wherein a display sheet is mounted on, and affixed to, said toothed gear.

14. An apparatus as defined in claim 13, wherein said display sheet has a reflective upper surface.

15. An apparatus as defined in claim 14, wherein said reflective upper surface is a mono- or multi-coloured surface.

16. An apparatus as defined in claim 15, wherein said reflective surface is mono-coloured.

17. An apparatus as defined in claim 16, wherein said reflective surface is a silver reflective material.

18. An apparatus as defined in claim 17, wherein said silver reflective material is a holographic foil.

19. An apparatus as defined in claim 15, wherein said reflective surface is multi-coloured.

20. An apparatus as defined in any one of claims 13 to 19, wherein said display sheet is sized to at least cover said toothed gear.

21. An apparatus as defined in claim 20, wherein said display sheet is of a size substantially larger than said toothed gear.

22. An apparatus as defined in claim 21 which further includes a spacer positioned on said axle and between said toothed gear and said display sheet to allow a staggered overlap or overlay of adjacent said display sheets.

23. An apparatus as defined in any one of claims 1 to 22, wherein said support surface is manufactured from, or associated with a ferromagnetic material.

24. An apparatus as defined in claim 23, wherein said support surface is associated with a ferromagnetic material.

25. An apparatus as defined in claim 24, wherein said support surface includes a first layer having an upper surface upon which is placed each of said display elements and adapted to be visually attractive and a second layer of said ferromagnetic material positioned on or near the under surface of said first layer and sufficiently proximate to maintain attachment of each of said display elements on said first layer.

26. An apparatus as defined in any one of claims 1 to 25, wherein said support surface is adapted to enable said display elements to be positioned on each side thereof.

27. An apparatus as defined in any one of claims 1 to 26, wherein said driving means for rotating said at least one display element is a direct current electric motor.

28. An apparatus as defined in claim 27, wherein said electric motor is powered by a means from the group including battery, solar or mains power.

29. An apparatus as defined in claim 27 or claim 28, wherein said electric motor is positioned on the same side of said support surface as said display element and is driveably coupled to a drive gear which, in turn, is driveably coupled to an adjacent display element.

30. An apparatus as defined in claim 27 or claim 28, wherein said electric motor is positioned on the side of said support surface opposite to that upon which said display element is placed and is driveably coupled to a drive gear which, in turn, is driveably coupled to said display element.

31. An apparatus as defined in claim 27 or claim 28, wherein said electric motor is positioned on one side of said support surface as convenient and has a shaft passing through said support surface driveably coupled to a drive gear which can be driveably coupled to an adjacent display element, and wherein said motor is further adapted to be movable substantially orthogonal to the plane of said support surface so that said drive gear can engage a said display element on either side of said support surface as required.

32. An apparatus as defined in claim 27 or claim 28, wherein said electric motor is positioned on one side of said support surface and has a shaft passing through said support surface, said shaft having a first drive gear and a second drive gear, said first gear driveably coupled to an adjacent display element on one side of said support surface and said second gear being driveably coupled to an adjacent display element on the other side of said support surface.
